(19) United States
(12) Patent Application Publication
(10) Pub. No.: US 2020/0394632 A1
(43) Pub. Date: Dec. 17, 2020

(54) REMOTE KEY INJECTION FOR INITIALIZING PAYMENT TERMINALS

(71) Applicants: Naman Bansal, Bellevue, WA (US); Pankaj Taneja, Bellevue, WA (US)

(72) Inventors: Naman Bansal, Bellevue, WA (US); Pankaj Taneja, Bellevue, WA (US)

(21) Appl. No.: 16/438,464

(22) Filed: Jun. 12, 2019

(51) Int. Cl. G06Q 20/20; H04L 9/08; G06F 9/54

(52) U.S. Cl. CPC G06Q 20/202; G06F 9/547; H04L 9/0822

(57) ABSTRACT

A system creates a remote approach to initialize payment terminals. In one embodiment, aspects of the invention maintain a database in a distributed manner to map all the keys for the vendors and remotely inject the keys into payment terminals to initialize the terminals without jeopardizing security of the devices.

### TECHNICAL FIELD

Embodiments discussed herein generally relate to remotely injecting encryption to payment terminals.

### BACKGROUND

Payment terminals do wonders when consumers stand next to them at checkout counters or wait for them to complete online transactions. Once these payment terminals receive payment information, within seconds and regardless of where you are in the world, consumers are notified whether the payment is successful. However, without the initial setup, these terminals may be prone to attacks or hacks.

Existing setup of the payment terminal is cumbersome. It starts with, once a new payment terminal is manufactured, sharing of a shared key between the terminal manufacturer and a payment gateway provider. The shared key is first generated or initiated from a Base Derivation Key (BDK). Before the shared key is injected or entered into the terminal, the shared key is sent via physical mailing addresses to the key custodians where each key custodian only receives a portion of the key. In addition, the mailing addresses are different, but all part of the terminal manufacturer. Once the custodians receive all pieces of the shared key, the key is manually injected, sometimes along with a key serial number, into the payment terminal.

Once the terminal receives such key initiated by the BDK, an algorithm known as Derived Key Per Transaction (DUKPT) algorithm that generates a pool of encryption keys and encrypts the User Personal data (e.g., CARD DATA) with one of the encrypted keys before sending it to payment gateways. A new, non-reusable key is generated for each transaction and cannot lead back to the original base key.

This long manual process involving multiple parties to inject keys to encrypt payment data originating from payment terminals is time-consuming to say the least. Moreover, the process involves significant costs and delays for all parties as well.

Aspects of the invention attempt to address the deficiencies of the existing approach.

### SUMMARY

Embodiments of the invention create a remote approach to initialize payment terminals. In one embodiment, aspects of the invention maintain a database in a distributed manner to map all the keys for the vendors and remotely inject the keys into payment terminals to initialize the terminals without jeopardizing security of the devices.

### BRIEF DESCRIPTION OF THE DRAWINGS

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

FIG. 1 is a system diagram for remotely initializing a payment terminal according to one embodiment.

FIG. 2 is a diagram illustrating a data structure in a database maintaining keys for the payment terminal according to one embodiment illustrated in FIG. 1.

FIGS. 3A to 3B are diagrams illustrating a set of GUI for managing remote initiation of a payment terminal according to one embodiment.

FIG. 4 is a flowchart illustrating a computerized method according to one embodiment.

FIG. 5 is a diagram illustrating a portable computing device according to one embodiment.

FIG. 6 is a diagram illustrating a remote computing device according to one embodiment.

### DETAILED DESCRIPTION

Embodiments may now be described more fully with reference to the accompanying drawings, which form a part hereof, and which show, by way of illustration, specific exemplary embodiments may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure will be thorough and complete, and will fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

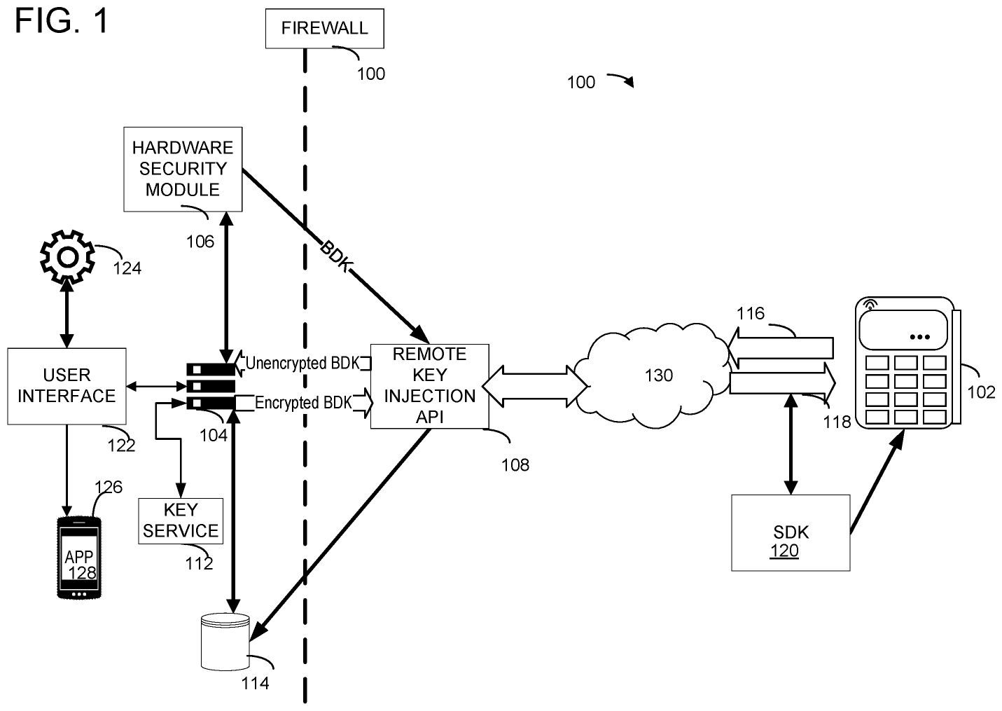

Referring to FIG. 1, a system 100 for remotely initiating a payment terminal 102. In one example, the payment terminal 102 may be a new payment device that has not been security authenticated to handle payment transactions. For example, the payment terminal 102 may be a newly manufactured device from a manufacturer. In another example, the payment terminal 102 may be a new model of a payment terminal that has gone through testing and is waiting to be certified or authenticated.

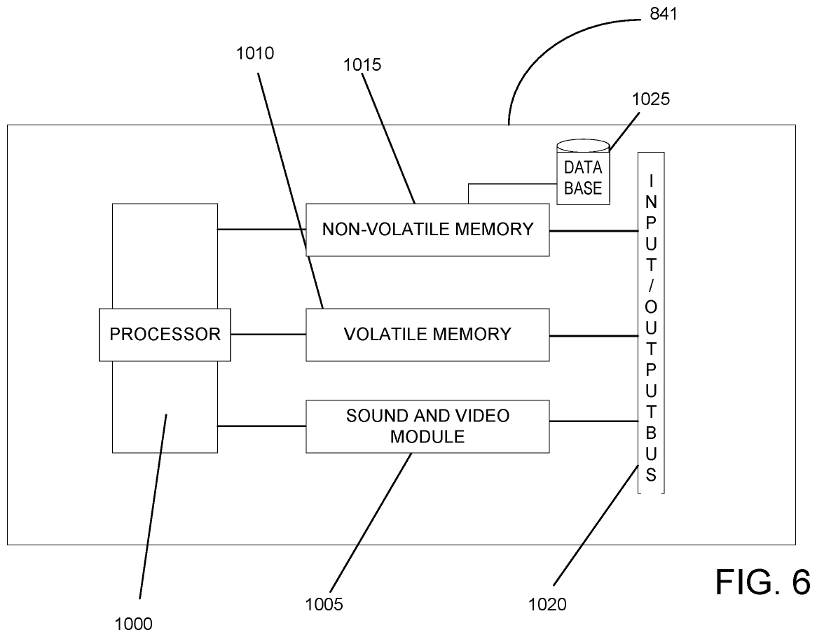

In one aspect, the system 100 may enable remote initiation of the payment terminals without resorting to the mundane, time-consuming and error-prone process of physically mailing a portion of the initiation security key to the payment terminal 102. In one example, the system 100 includes a server 104 for managing the overall process. For example, the server 104, as disclosed in FIG. 6, may be a distributed server system that has many individual server devices or computers across various geographical areas. The server 104 may further be connected via wired or wireless networks to a hardware security module (HSM) 106. In one example, the server 104 may be configured by computer-executable instructions to execute and process instructions such as to delegate certain tasks to the HSM 106 as the HSM 106 may be a dedicated hardware device for certain tasks. For example, the HSM 106 may be delegated to perform an initial task of sending a Base Derivation Key (BDK) to a remote key injection application programming interface (API) 108. In one embodiment, the BDK sent by the HSM 106 may not be encrypted. In another embodiment, the server 104 and the HSM 106 may be configured to be within a firewall 110 while the API 108 may be configured to be outside the firewall 110.

In another embodiment, the API 108 may be configured to embed BDK in a specific API format before forwarding it from outside the firewall 110 to a key service 112 via the server 104. In one example, the key service 112 may be a computer or a plurality of computers that is configured to execute computer-executable instructions to generate encryption keys, such as encrypted BDK. For example, the key service 112 may be configured to execute computer-executable instructions that are embodied in a function that is based on elliptic curve cryptography, such as Elliptic-curve Diffie-Hellman (ECDH) key generation. For example, the key service 112 may receive the BDK via the API 108 and the BDK is input into the key service 112 to generate an encrypted BDK.

In another embodiment, the API 108 may additional store the encrypted

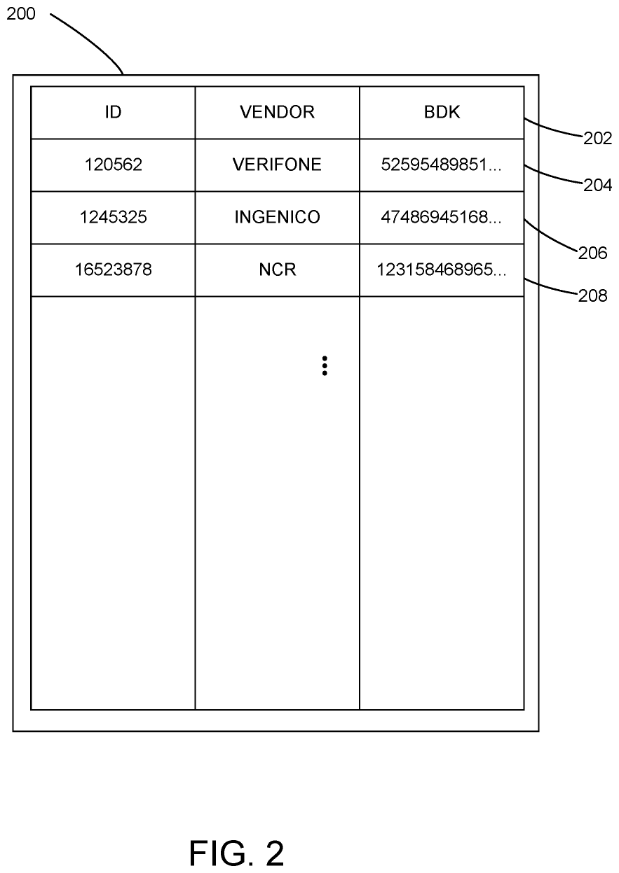

BDK in a database 114, which may also be connected or coupled to the server 104. In one example, the database 114 and the key service 112, similar to the HSM 106 may be configured behind the firewall 110 of the server 104. In another embodiment, the database 114 may be configured to store the encrypted BDK in a table, for example, such as a table 200 in FIG. 2. For example, the table 200 may include columns and rows having data entries. For example, a row 202 may include field for an ID (e.g., identification number for vendor), a vendor (e.g., vendor name or label), and/or a BDK (e.g., for encrypted BDK). In one example, the BDK field may be masked or truncated and the full set of information upon clicking the field. For example, FIG. 2 illustrates rows 204, 206, 208 showing examples of the entries into the fields of the table 200.

Referring back to FIG. 1, once the encrypted BDK is ready in the API 108 and/or stored in the database 114, the server 104 may be ready for receiving requests from manufacturers who may wish to activate or initialize the new payment terminal 102. In one embodiment, the generation of the BDK by the HSM 106 may be done periodically. In another embodiment, the manufacturer may have a periodic production of new payment terminals so the generation of the BDK may coincide with such schedule. In a further embodiment, the manufacturer may communicate with the server 104 separately to communicate or request the need to a new set of BDK for initializing the payment terminal 102. Moreover, the initialization or activation of the payment terminal 102 may be a one-time event or one-time activation. As the terminal 102 may include specific derivation algorithms to generate keys for each transaction, even if eavesdroppers who steal a transaction key and try to identify the initial BDK, the terminal 102 may not be easily compromised as a new transaction key is generated from the initial BDK.

In one example, the terminal 102 may transmit a request 116 to the API 108 to obtain the encrypted BDK via computer networks 130, such as the Internet. The server 104 may configure the API 108 to respond with a response 118 with the encrypted BDK after reviewing the database entries stored in the database 114 (e.g., table 200). In one embodiment, a software development kit (SDK) service 120 may be further include a decryption kit or a decryption software package used by the manufacturer to decrypt the encrypted BDK.

Once decrypted, the terminal 102 may receive the decrypted BDK to initialize or activate so that it may be used to generate a pool of transaction keys for future transactions. In another embodiment, the SDK service 120 may provide an acknowledgement of receipt from the server 104 that the encrypted BDK is received or processed by the terminal 102.

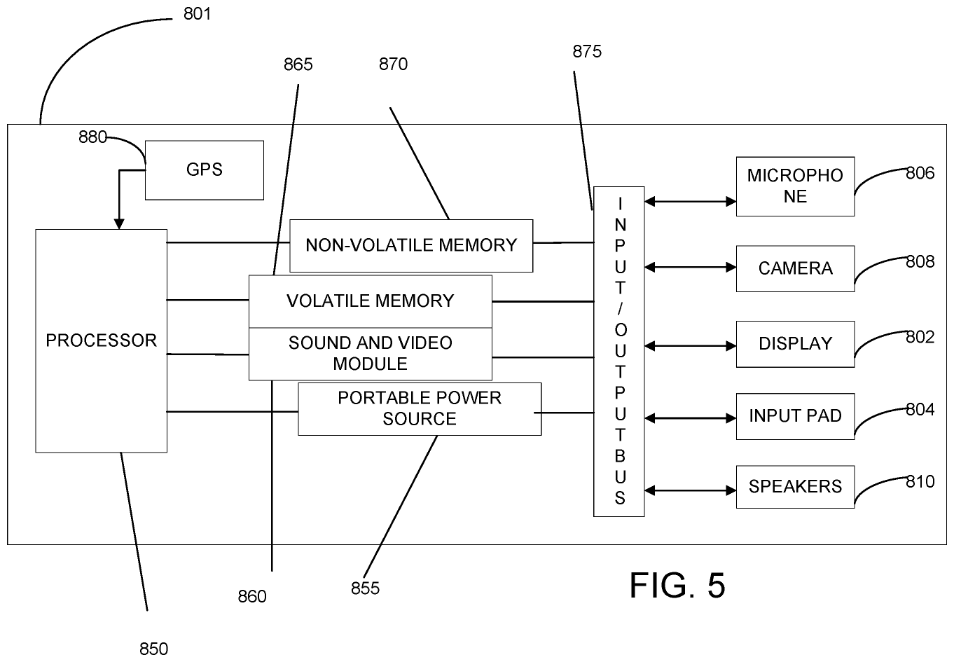

In a further embodiment, the server 104 may provide a user interface portal 122 for users or administrators. For example, the portal 122 may provide access to administrators at the manufacturer to make request or view initialization or activation status or even status of the server 104. In another embodiment, the portal 122 may provide a configuration 124 for the users to configure settings associated with the portal 122. In a further example, the portal 122 may further be configured to be coupled with a mobile device 126, such as the one discussed in FIG. 5, such as having an app 128 to access the portal 122 in a more convenient manner on the mobile device 126.

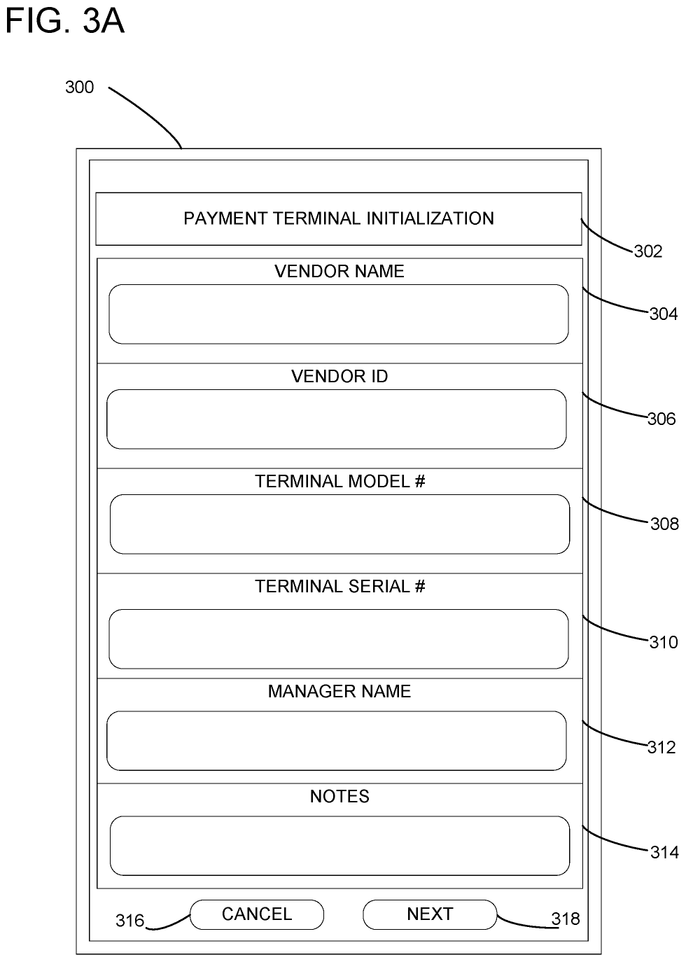

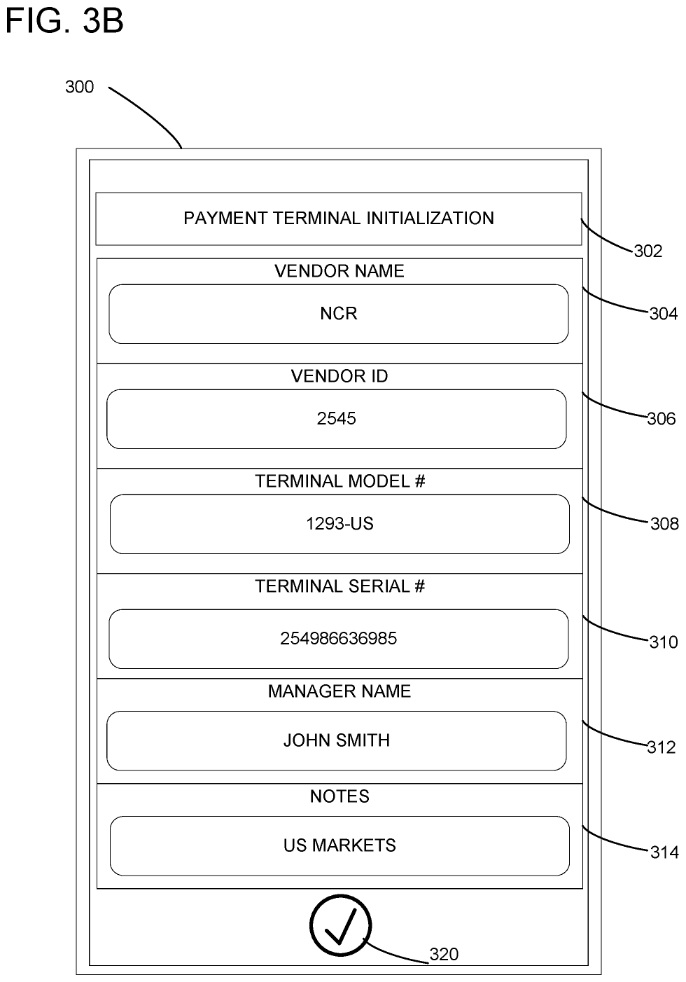

Referring now to FIG. 3A, a screenshot 300 illustrating of the portal 122 as rendered on the mobile device 126 according to one embodiment of the invention. For example, the screenshot 300 may display a title bar 302 indicating the scope of the fields therein for activating or initialization of a payment terminal, such as the terminal 102. For example, the fields may include: a vendor name field 304, a vendor ID field 306, a terminal model number field 308, a terminal serial number field 310, a manager name field 312, and a notes field 314. It is to be understood that other fields may be added without departing from the scope or spirit of embodiments of the invention.

In another embodiment, the screenshot 300 may provide a next button 318 to proceed to a next screen or a cancel button to cancel 316 the request.

FIG. 3B illustrates a confirmation page from FIG. 3A where a checkmark icon 120 indicates that the request has been received and entered in to the server 104, for example. In one embodiment, the request may trigger the generation of the BDK by the HSM 106. In such an embodiment, upon receiving the request, the server 104 is configured to trigger the generation of the BDK by the HSM 106 and subsequent actions as described above. Moreover, the server 104 may perform audit or verification on the database 114 to ensure proper entries therein. In another embodiment, the request by the administrator or manager of the manufacturer of the payment terminal 102 may be separate from the request initiated by the terminal 102 itself. For example, the terminal 102 may be configured to initiate the request to the API 108 as preconfigured or configured when the terminal 102 is connected to another computer.

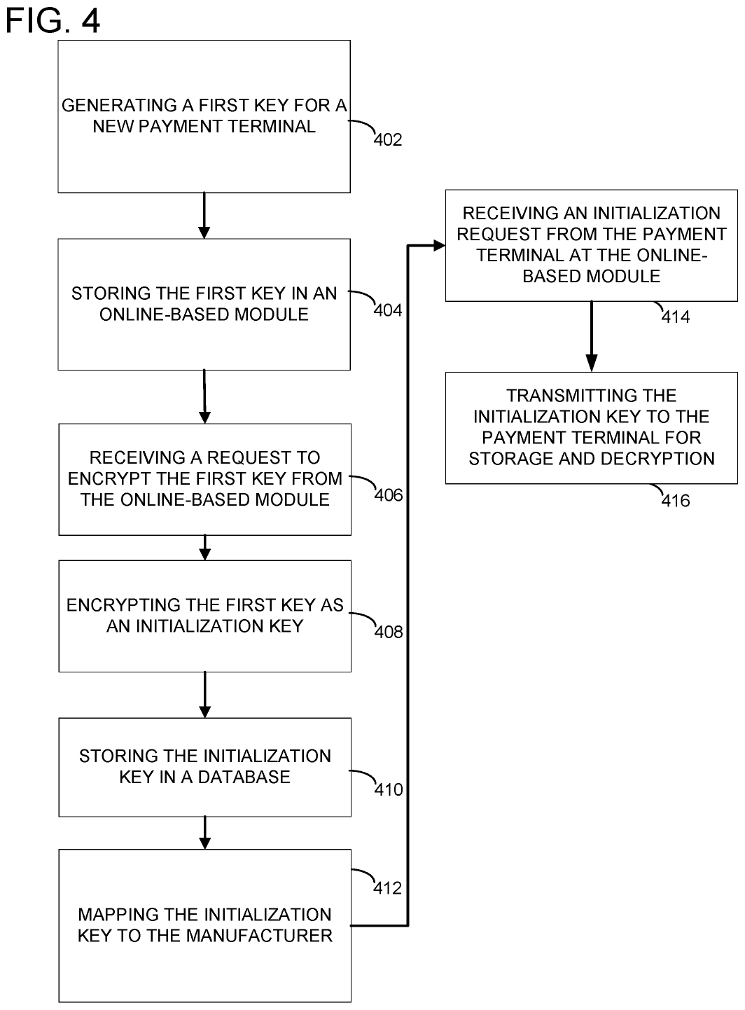

Referring now to FIG. 4, a flowchart illustrates a computer-executable method for initializing a payment terminal according to one embodiment of the invention. At 402, a first key for a new payment terminal is generated. For example, the payment terminal is new and is needed for initialization or activation before it can securely process payment transactions. At 404, the first key is stored in an online-based module, such as the API 108 in FIG. 1. At 406, a request is received from the online-based module to encrypt the first key. For example, the first key may be an unencrypted BDK and before the payment terminal 102 may receive such first key, it may be encrypted by the server 104. In one example, the server 104 may execute other functions for the encryption.

The first key is encrypted as an initialization key for the payment terminal at 408. At 410, the initialization key is stored in a database accessible by the server. At 412, the initialization key may further be mapped to the manufacturer. For example, table 200 in FIG. 2 may be an embodiment to map the initialization key to the manufacturer. At 414, the terminal may send an initialization request or the API may receive such initialization request for initialization. Upon receiving the request, at 416, the initialization key may be transmitted to the payment terminal for storage and decryption. In one embodiment, the server may provide a decryption kit or SDK to assist the terminal to decrypt the initialization key.

FIG. 5 may be a high level illustration of a portable computing device 801 communicating with a remote computing device 841 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a mobile device 112 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi® (802.11 standard), BLUETOOTH, cellular communication or near field communication devices. The communication may be direct to the computing device 841 or may be through a communication network 102 such as cellular service, through the Internet, through a private network, through BLUETOOTH, etc. FIG. 5 may be a simplified illustration of the physical elements that make up a portable computing device 801 and FIG. 6 may be a simplified illustration of the physical elements that make up a server type computing device 841.

FIG. 5 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 6. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be general purpose computers that may have, among other elements, a microprocessor (such as from the Intel® Corporation, AMD®, ARM®, Qualcomm®, or MediaTek®); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS®, UNIX®, LINUX®, MAC® OS®, iOS®, or Android®. It is contemplated, however, that any suitable operating system may be used for the present invention. The servers may be a cluster of web servers, which may each be LINUX® based and supported by a load balancer that decides which of the cluster of web servers should process a request based upon the current request-load of the available server(s).

The user devices, computers and servers described herein may communicate via networks, including the Internet, wide area network (WAN), local area network (LAN), Wi-Fi®, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of embodiments will become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiments to the embodiments illustrated.

The present disclosure provides a solution to the long-felt need described above. In particular, the systems and methods described herein may be configured for improving initializing new payment terminal devices. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. A computer-implemented method for remote key initialization of a payment terminal comprising:
generating, configured by a computer server, a first key for a payment terminal from a manufacturer;
storing, configured by the computer server, the first key in an online-based module;
receiving, by the computer server, a request to encrypt the first key from the online-based module;
encrypting, by the computer server, the first key as an initialization key;
storing, by the computer server, the initialization key in a database;
mapping, by the computer server, the initialization key to the manufacturer;
receiving, by the computer server, an initialization request from the payment terminal at the online-based module; and
in response to the received initialization request, transmitting, by the computer server, the initialization key to the payment terminal for storage and decryption.

2. The computer-implemented method of claim 1, wherein the first key is an unencrypted base derivation key (BDK).

3. The computer-implemented method of claim 1, wherein the request comprises an application programming call request.

4. The computer-implemented method of claim 1, further comprising providing, by the computer server, a decryption kit to the payment terminal for decrypting the initialization key.

5. The computer-implemented method of claim 1, wherein the online-based module is located outside of a firewall of the computer server.

6. The computer-implemented method of claim 5, wherein encrypting comprises encrypting, by an encryption module behind the firewall of the computer server.

7. The computer-implemented method of claim 1, further comprising receiving a confirmation, by the computer server, that the payment terminal has activated the initialization key.

8. A system for remote key injection to a payment terminal for a one-time initialization comprising:
a hardware security generator for generating a first key for a payment terminal of a manufacturer;
an online-based portal for storing the first key;
a central server, coupled to the hardware security generator and the online-based portal, is configured to execute computer-executable instructions, wherein the computer-executable instructions comprising:
receiving a request to encrypt the first key;
calling an encryption unit for encrypting the first key in response to the request;
storing the first encrypted key in a database coupled to the central server;
mapping the first encrypted key in the database to the manufacturer;
receiving an initialization request from the payment terminal via the online-based module; and
in response to the received initialization request, transmitting the first encrypted key to the payment terminal from the database for storage and decryption in the payment terminal.

9. The system of claim 8, wherein the first key is an unencrypted base derivation key (BDK).

10. The system of claim 8, wherein the request comprises an application programming call request.

11. The system of claim 8, wherein the central server is further configured to provide a decryption kit to the payment terminal for decrypting the initialization key.

12. The system of claim 8, wherein the online-based module is located outside of a firewall of the computer server.

13. The system of claim 12, wherein encrypting comprises encrypting, by an encryption module behind the firewall of the computer server.

14. The system of claim 8, further comprising receiving a confirmation, by the computer server, that the payment terminal has activated the initialization key.

15. The system of claim 8, further comprising a user interface portal having graphical user interface (GUI) for receive a user request from the manufacturer.

16. A non-transitory computer readable medium having stored thereon a computer-implemented method for remote key initialization of a payment terminal, said computer-executable instructions comprising:
generating, configured by a computer server, a first key for a payment terminal from a manufacturer;
storing, configured by the computer server, the first key in an online-based module;
receiving, by the computer server, a request to encrypt the first key from the online-based module;
encrypting, by the computer server, the first key as an initialization key;
storing, by the computer server, the initialization key in a database;
mapping, by the computer server, the initialization key to the manufacturer;
receiving, by the computer server, an initialization request from the payment terminal at the online-based module; and
in response to the received initialization request, transmitting, by the computer server, the initialization key to the payment terminal for storage and decryption.

17. The non-transitory computer readable medium of claim 16, wherein the first key is an unencrypted base derivation key (BDK).

18. The non-transitory computer readable medium of claim 16, further comprising, configured by the computer server, a decryption kit to the payment terminal for decrypting the initialization key.

19. The non-transitory computer readable medium of claim 16, wherein the online-based module is located outside of a firewall of the computer server.

20. The non-transitory computer readable medium of claim 19, wherein encrypting comprises encrypting, by an encryption module behind the firewall of the computer server.
